(19) United States
(12) Patent Application Publication
(10) Pub. No.: US 2007/0027709 A1
(43) Pub. Date: Feb. 1, 2007

(54) E-Commerce System and Method for Automated Confirguation of Trading Relationships

(75) Inventors: Thomas A. Grate, Issaquah, WA (US); Bryan J. Nylin, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/534,051

(22) Filed: Sep. 21, 2006

Related U.S. Application Data
(63) Continuation of application No. 09/286,822, filed on Apr. 5, 1999, now abandoned.

(51) Int. Cl. G06Q 99/00

(52) U.S. Cl. 705/1; 705/80

(57) ABSTRACT

An electronic commerce system allows trading partners to automatically configure a trading relationship for network-based business exchanges. The system has a first computer system at a first trading partner and a second computer system at a second trading partner. The computer systems are interconnected via a network, such as the Internet. The trading relationship governs how the trading partners' computer systems connect to one another and communicate over the network. The automated configuration process involves two phases. In a first phase, each of the trading partners enters all of its own configuration details and publishes that information to a URL (universal resource locator) at a Web site (hosted by the trading partner, or elsewhere). In a second phase, one of the trading partners attempts to forge a trading relationship with a potential trading partner by entering the URL for the potential trading partner's configuration details and pulling the details down from the Web site. The first trading partner then automatically creates and configures the trading relationship for online exchanges with the potential trading partner.

### RELATED APPLICATIONS

This is a continuation of and claims priority to U.S. patent application Ser. No. 09/286,822 filed Apr. 5, 1999 entitled “E-Commerce System and Method for Automated Configuration of Trading Relationships” by inventors Thomas A. Grate and Bryan J. Nylin.

### TECHNICAL FIELD

This invention relates to systems and methods that support electronic commerce and other business relationships over a network, such as the Internet. More particularly, this invention relates to the exchange of configuration details between trading partners for use in establishing a trading relationship.

### BACKGROUND

The Internet and World Wide Web (“Web”) provide a new frontier for electronic commerce. Merchants are developing sites on the Web that consumers can access and order goods and/or services. Businesses are using the Web to automate and manage electronic communications amongst themselves, as well as with their distributors, resellers, and suppliers.

Businesses engaged in commerce over the Internet exchange configuration details to establish a connection between them. Business document gateways are tools used to help business trading partners set up and manage electronic trading relationships. One example of a business document gateway is the Commerce Interchange Pipeline (CIP) from Microsoft Corporation. CIP is a facility for interchanging business documents between trading partners in a manner that is independent of data format and data transport. Commerce Interchange Pipeline Manager (CIPM) is a tool that manages trading partners and the electronic relationships with those trading partners implemented on the Commerce Interchange Pipeline (CIP).

One problem with existing business document gateways is that they require a user to manually enter all information for the home company and all information for every trading partner with whom the home company trades. Unfortunately, manually entering information for thousands of trading partners can be tedious, time consuming, and is prone to error.

### SUMMARY

This invention concerns an electronic commerce system that allows potential trading partners to automatically configure a trading relationship for network-based business exchanges.

In one implementation, the system has a first computer system at a first trading partner and a second computer system at a second trading partner. The computer systems are interconnected via a network, such as the Internet.

The automated configuration process involves two phases. In a first phase, each of the trading partners enters its own configuration details (e.g., trading partner name, mailing address, Web site address, email, network and data communication protocol(s), cryptographic capabilities, digital certificates, etc.). As an example, a user/operator at each trading partner manually enters the information via a graphical user interface. Once the information is entered, the trading partner publishes that information to a URL (universal resource locator) at a Web site (hosted by the trading partner, or elsewhere).

In a second phase, one of the trading partners attempts to forge an electronic trading relationship with a potential trading partner. The first trading partner enters the URL for the potential trading partner's configuration details and pulls the details down from the Web site addressed by the URL. The first trading partner then automatically creates and configures the trading relationship for online exchanges with the potential trading partner. This can be done by creating a trading record and automatically populating that record using the potential trading partner's configuration details.

### BRIEF DESCRIPTION OF THE DRAWINGS

FIG. 1 shows a network architecture having two trading partners interconnected via a distributed network.

FIG. 2 shows an exemplary computer that can be configured as a server computer at each of the trading partners.

FIG. 3 is a flow diagram showing a two-phase automated configuration process to establish an electronic trading relationship between the trading partners.

### DETAILED DESCRIPTION

An electronic commerce system allows potential trading partners to automatically configure a trading relationship for network-based business exchanges. The trading relationship governs how the trading partners' computer systems connect to one another and communicate over a network. The system scales to many participating trading partners, but is described in the context of two trading partners.

Architecture

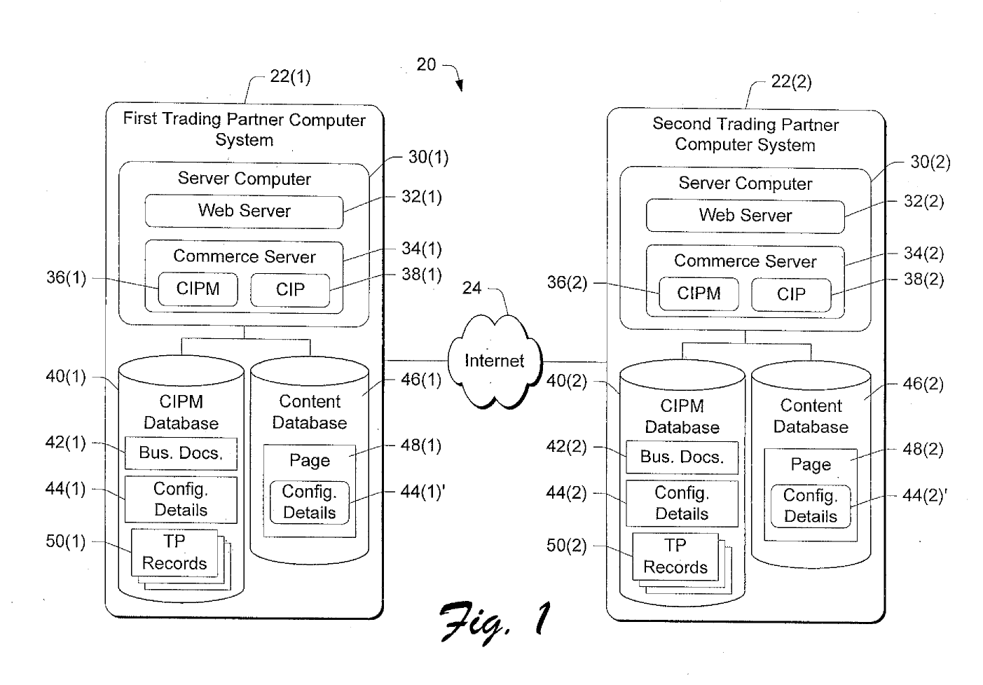

FIG. 1 shows a network system 20 having a first computer system 22(1) at a first trading partner and a second computer system 22(2) at a second trading partner. A network 24, such as the Internet or other wide area network, interconnects the computer systems 22(1) and 22(2). The trading partners are involved in online commerce and hope to establish a trading relationship that allows the exchange of business documents or other data over the Internet 24. The trading relationship governs how the computer systems 22(1) and 22(2) connect and communicate with one another.

The computer systems 22(1), 22(2) each have a server computer 30(1), 30(2) that may be implemented as a single computing unit or a clustered group of computing units. The server computers 30(1), 30(2) n Web server software 32(1), 32(2) to facilitate communication over the Internet 24, such as receiving requests from other clients and returning responses to those clients. One example of a Web server is the Internet Information Server (IIS) from Microsoft Corporation.

The server computers 30(1), 30(2) also run commerce server software 34(1), 34(2) to facilitate commerce and other business related correspondence over the Internet 24. An example of the commerce server is the Site Server, Commerce Edition, from Microsoft Corporation.

The commerce servers 34(1), 34(2) implement business document gateways 36(1), 36(2), which are shown implemented as Microsoft's Commerce Interchange Pipeline (CIP). The document gateways 36(1), 36(2) facilitate the interchange of business documents between trading partners. The commerce servers 34(1), 34(2) also implement trading partner management tools 38(1), 38(2) that manage electronic relationships with other trading partners. The tools are shown implemented as Microsoft's Commerce Interchange Pipeline Manager (CIPM).

The computer systems 22(1), 22(2) each have a CIPM database 40(1), 40(2) to store business documents 42(1), 42(2) used by the CIPM software 38(1), 38(2). Examples of business documents include purchase orders, invoices, receipts, shipping notices, and so forth. The CIPM databases 40(1), 40(2) also store the trading partner's configuration details 44(1), 44(2) used to configure trading relationships with other trading partners.

The configuration details are entered manually by a user/operator of the trading partner. The configuration details include business information as trading partner name, mailing address, Web site address, and email address. The configuration details also include system information such as the various network and data communication protocol(s) supported by the computer systems and the type of software being run on each server. The configuration details might further include security information, such as cryptographic capabilities, digital certificates, and so forth. The security information might dictate, for example, whether the trading partners exchange information over the Internet in an unsecured fashion, or employ a virtual private network (VPN) tunneled through the Internet to communicate using encrypted data.

The computer systems 22(1), 22(2) each have a database 46(1), 46(2) to store Web content, such as Web pages and other documents. For example, the pages may be HTML (hypertext markup language) documents or ASP (active server page) documents.

One or more pages 48(1), 48(2) hold a copy of the configuration details 44(1)′, 44(2)′ stored in the CIPM databases 40(1), 40(2). That is, the configuration details that were entered manually are posted to the trading partner's Web site (or another designated site) at a URL (universal resource locator) that is publicly accessible. As a result, when two partners create a trading relationship, each trading partner visits the other's Web site using the given URLs and download the Web pages 48(1), 48(2) with the configuration details 44(1)′, 44(2)′ for use in automated configuration of the trading relationship. In one implementation, the CIPM programs 38(1), 38(2) create trading partner records 50(1), 50(2) and automatically populate them with the other trading partner's configuration details.

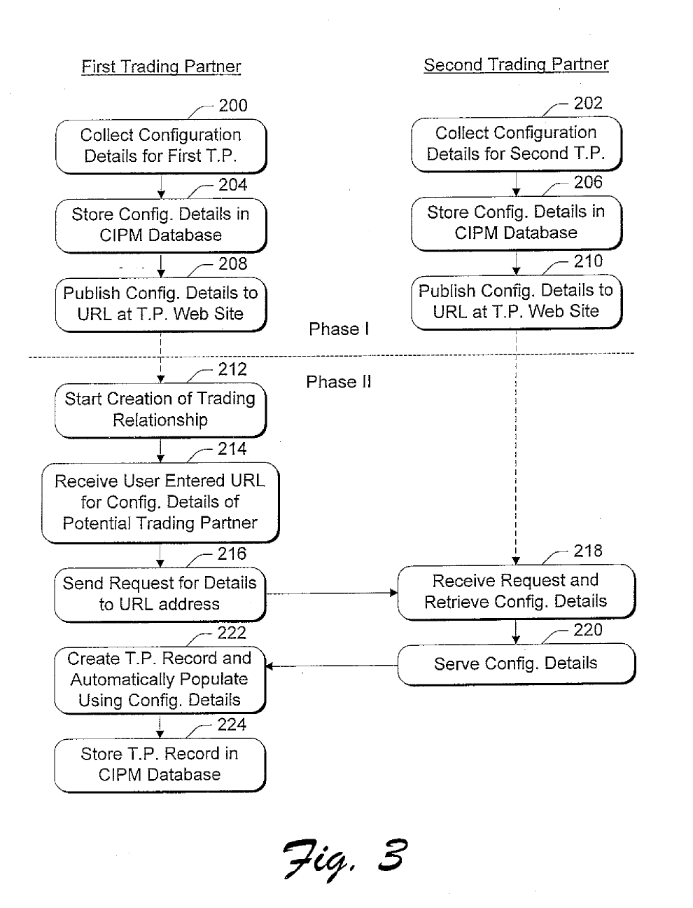

One exemplary implementation of the automated configuration process is described below under the heading “Operation” and with reference to FIG. 3. Prior to explaining this process, however, an exemplary implementation of a computer is used to implement the server computers 22(1), 22(2) is described.

Exemplary Server Computer

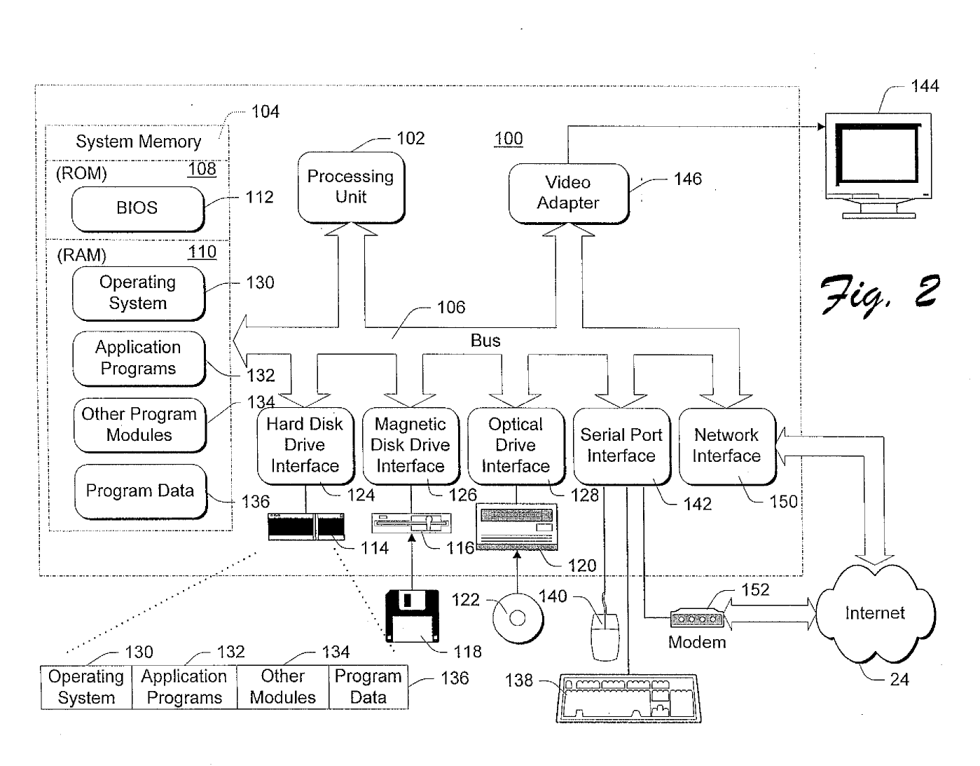

FIG. 2 shows an exemplary implementation of a server computer 22(1), 22(2). The computer is a general-purpose computing device in the form of a conventional personal computer 100 that is configured to operate as a Web server.

Computer 100 includes a processing unit 102, a system memory 104, and a bus 106 that couples various system components including the system memory 104 to the processing unit 102. The bus 106 represents one or more of any of several types of bus structures, including a memory bus or memory controller, a peripheral bus, an accelerated graphics port, and a processor or local bus using any of a variety of bus architectures. The system memory 104 includes read only memory (ROM) 108 and random access memory (RAM) 110. A basic input/output system 112 (BIOS) is stored in ROM 108.

Computer 100 also has one or more of the following drives: a hard disk drive 114 for reading from and writing to a hard disk, a magnetic disk drive 116 for reading from or writing to a removable magnetic disk 118, and an optical disk drive 120 for reading from or writing to a removable optical disk 122 such as a CD ROM or other optical media. The hard disk drive 114, magnetic disk drive 116, and optical disk drive 120 are connected to the bus 106 by a hard disk drive interface 124, a magnetic disk drive interface 126, and an optical drive interface 128, respectively. The drives and their associated computer-readable media provide nonvolatile storage of computer readable instructions, data structures, program modules and other data for the personal computer. Although a hard disk, a removable magnetic disk and a removable optical disk are described, other types of computer readable media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 130, one or more application programs 132, other program modules 134, and program data 136. The programs 132 or modules 134 include, for example, the commerce server and Web server programs installed at each trading partner,

A user may enter commands and information into the personal computer 100 through input devices such as keyboard 138 and pointing device 140. Other input devices (not shown) may include a microphone, joystick, game pad, satellite dish, scanner, or the like. These and other input devices are often connected to the processing unit 102 through a serial port interface 142 that is coupled to the bus 106, but may be connected by other interfaces, such as a parallel port, game port, or a universal serial bus (USB).

A monitor 144 or other type of display device is also connected to the bus 106 via an interface, such as a video adapter 146. The monitor 144 is used to present a graphical user interface that assists a user/operator in entering the configuration details of the trading partner. In addition to the monitor, personal computers typically include other peripheral output devices (not shown) such as speakers and printers.

The server computer 100 is connected to the Internet 24 through a network interface or adapter 150; a modem 152, or other means for establishing communications over the network. The modem 152, which may be internal or external, is connected to the bus 106 via the serial port interface 142.

Operation

The architecture shown in FIG. 1 enables automated configuration of trading partners who are creating an electronic trading relationship. The automated configuration process has two phases. The first phase involves creation and publishing of each trading partner's configuration details. In this phase, each trading partner enters its configuration details and posts it to a Web site at a selected URL. The second phase involves establishment of a trading relationship that will govern the interactions between the trading partners' computing systems. In the second phase, a potential trading partner accesses the configuration details of another trading partner at the given URL and uses the details to automatically configure the electronic trading relationship.

FIG. 3 shows the two-phase automated configuration process. The process can be performed in software, hardware, or a combination of hardware and software, and is described with reference to the architecture of FIG. 1.

At step 200 and 202, the configuration details for each trading partner 22(1), 22(2) are collected. In one implementation, CIPM program 36(1), 36(2) presents one or more graphical user interface (UI) windows or dialog boxes that enable a user/operator to manually enter the configuration details. Once collected, the configuration details 44(1), 44(2) are stored in the trading partners' CIPM databases 40(1), 40(2) (steps 204 and 206).

At steps 208 and 210, each trading partner posts its configuration details to a URL at a Web site that is accessible over the Web. In one implementation, the Web site is hosted by the respective computer systems 22(1), 22(2) and hence, the URL coincides with the trading partner's own Web site, such as “http://www.company.com/trading_partner info.cio”. Alternatively, the Web site may be independent of the trading partners, such as a site for an organization of trading partners.

The user/operator who enters the configuration details on behalf of a trading partner clicks a control (e.g., a “POST” or “PUBLISH” icon) or checks an appropriate box in the graphical UI window to publish the configuration details to the URL. The URL may be selected by the user/operator, or automatically assigned by the CIPM program. The posted configuration details 44(1)′, 44(2)′ are shown in FIG. 1 as part of pages 48(1), 48(2), which are stored in content databases 46(1), 46(2) and can be served by Web server 32(1), 32(2) to requesting trading partners.

This completes the creation and publishing phase of the automated configuration process. The second phase concerns establishment of a trading relationship. For discussion purposes, suppose that the first trading partner 22(1) is attempting to establish a relationship with the second trading partner 22(2).

At step 212, the first trading partner 22(1) initiates creation of a new trading relationship with the second trading partner 22(2). The user/operator at the first trading partner 22(1) uses the CIPM program 36(1) to set up the information needed to communicate and interact with the second trading partner 22(2) over the Internet. The user/operator enters the URL address of the configuration details for the second trading partner (step 214). In this example, suppose the URL address is to the second trading partner's Web site and particularly, to Web page 48(2). The URL is obtained directly from the second trading partner, or from a public directory listing the URLs of various partners.

In response to entry of the URL, the first trading partner 22(1) sends a request with the URL over the Internet 24 to the second trading partner 22(2) (step 216). The Web server 32(2) at the second trading partner 22(2) handles the request and uses the URL to retrieve the page 48(2) with the configuration details 44(2)′ (step 218). The Web server 32(2) then serves the page back to the first trading partner 22(1) over the Internet 24 (step 220).

At step 222, the CIPM 36(1) executing at the first trading partner's server computer 30(1) creates a new trading partner record 50(1) and automatically populates that record with the configuration details 44(2)′ retrieved from the second trading partner's Web site. The new trading partner record 50(1) is then stored in the CIPM database 40(1) for later use in online business exchanges between the two trading partners (step 224). As one exemplary implementation, the data retrieved from the trading partners web site can be in XML format.

The process is advantageous over prior art systems in that the trading relationships are established automatically. The user/operator no longer needs to manually input the configuration details of every trading partner. When scaled to thousands of trading partners, this results in a substantial and significant gain in efficiency and administrative costs.

### CONCLUSION

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method for establishing a new trading relationship between new trading partners involved in electronic commerce, the method comprising:
retrieving configuration details associated with a new trading partner from a remote site; and
automatically configuring a new trading relationship with the new trading partner using the configuration details.

2. A method as recited in claim 1, wherein the retrieving comprises addressing a URL (universal resource locator) to access the configuration details.

3. A method as recited in claim 1, wherein the automatically configuring comprises:
creating a new trading partner record; and
automatically populating the new trading partner record with the configuration details.

4. In an electronic commerce trading system involving exchanges of commerce information over a network, a method comprising:
collecting configuration details associated with a new trading partner participating in the commerce trading system; and
publishing the configuration details to a Web site.

5. A method as recited in claim 4, wherein the collecting comprises presenting a graphical user interface to enable a user to enter the configuration details.

6. A method as recited in claim 4, wherein the publishing comprises posting the configuration details to a URL (universal resource locator) at the Web site.

7. A method as recited in claim 4, wherein the Web site is associated with the new trading partner.

8. A method for establishing a new trading relationship between new trading partners involved in electronic commerce, the method comprising:
creating a trading partner record for a new trading partner;
retrieving configuration details associated with the new trading partner from a remote site; and
populating the trading partner record with the configuration details retrieved from the remote site.

9. A method as recited in claim 8, wherein the retrieving comprises addressing a URL (universal resource locator) to access the configuration details posted to a Web site.

10. A method for establishing a trading relationship between first and second new trading partners involved in electronic commerce, the method comprising:
collecting configuration details associated with the first new trading partner;
publishing the configuration details to a Web site;
creating, at the second new trading partner, a new trading partner record for the first new trading partner;
retrieving the configuration details associated with the first new trading partner from the Web site; and
populating the new trading partner record with the configuration details associated with the first new trading partner.

11. A method as recited in claim 10, wherein the collecting comprises presenting a graphical user interface to enable a user to enter the configuration details.

12. A method as recited in claim 10, wherein the publishing comprises publishing the configuration details in XML format.

13. A method as recited in claim 10, wherein the publishing comprises posting the configuration details to a URL (universal resource locator) at the Web site.

14. A method as recited in claim 13, wherein the retrieving comprises addressing the URL to access the configuration details posted to the Web site.

15. A system comprising:
a first computer system at a first new trading partner;
a second computer system at a second new trading partner;
a Web site;
the first computer system collecting configuration details associated with the first new trading partner and publish the configuration details to the Web site; and
the second computer system retrieving the configuration details from the Web site and automatically configure for a trading relationship with the first new trading partner using the configuration details.

16. A system as recited in claim 15, wherein the first computer system hosts the Web site.

17. A system as recited in claim 15, wherein the first computer system presents a graphical user interface to enable a user to enter the configuration details.

18. A system as recited in claim 15, wherein the first computer system posts the configuration details in XML format.

19. A system as recited in claim 15, wherein the first computer system posts the configuration details to a URL (universal resource locator) at the Web site.

20. A system as recited in claim 19, wherein the second computer system addresses the URL to access the configuration details.

21. A system as recited in claim 15, wherein the second computer system creates a new trading partner record and automatically populates the new trading partner record with the configuration details.

22. A electronic commerce system, comprising:
a first component at a first new trading partner, the first component collecting configuration details associated with the first new trading partner and publishing the configuration details to a Web site; and
a second component at a second new trading partner, the second component retrieving the configuration details from the Web site and automatically configuring a trading relationship with the second new trading partner using the configuration details.

23. A electronic commerce system as recited in claim 22, wherein the first component presents a graphical user interface to enable a user to enter the configuration details.

24. A electronic commerce system as recited in claim 22, wherein the first component posts the configuration details to a URL (universal resource locator) at the Web site.

25. A electronic commerce system as recited in claim 24, wherein the second component addresses the URL to access the configuration details.

26. A electronic commerce system as recited in claim 22, wherein the second component creates a new trading partner record and automatically populates the new trading partner record with the configuration details.

27. A software architecture for an electronic commerce system having new trading partners that exchange data over a network, comprising:
first program code stored on a computer-readable medium at a first new trading partner, the first program code having computer-executable instructions that, when executed by one or more processors, collect configuration details associated with the first new trading partner and publish the configuration details to a Web site; and
second program code stored on a computer-readable medium at a second new trading partner, the second program code having computer-executable instructions that, when executed by one or more processors, retrieve the configuration details from the Web site and automatically configure a new trading relationship with the second new trading partner using the configuration details.

28. In an electronic commerce trading system involving exchanges of commerce information over a network, a computer-readable medium at a computer system participating in the commerce trading system storing computer-executable instructions for:
collecting configuration details associated with a new trading partner that participates in electronic commerce; and
publishing the configuration details to a Web site.

29. In an electronic commerce trading system involving exchanges of commerce information over a network, a computer-readable medium at a computer system participating in the commerce trading system storing computer-executable instructions for:
creating a new trading partner record for a new trading partner that participates in electronic commerce;
retrieving configuration details associated with the new trading partner from a Web site; and
populating the new trading partner record with the configuration details retrieved from the Web site.

30. A method for establishing a new trading relationship between new trading partners involved in electronic commerce, the method comprising:
retrieving configuration details associated with a first new trading partner from a remote site by a second potential trading partner;
retrieving configuration details associated with the second new trading partner from a remote site by the first potential trading partner; and
automatically configuring a new trading relationship with the first and the second new trading partners using the configuration details.

31. A method as recited in claim 30, wherein the retrieving comprises addressing a URL (universal resource locator) to access the configuration details of the first and the second trading partners.

32. A method as recited in claim 30, wherein the automatically configuring comprises:
creating a new trading partner record; and
automatically populating the new trading partner record with the configuration details.

33. A method for establishing a new trading relationship between first and second new trading partners involved in electronic commerce, the method comprising:
collecting first and second configuration details associated with the first and the second new trading partners, respectively;
publishing the first and second configuration details to at least one Web site;
creating, at the second new trading partner, a new trading partner record for the first new trading partner;
creating, at the first new trading partner, a new trading partner record for the second new trading partner;
retrieving the configuration details associated with the first new trading partner from the Web site;
retrieving the configuration details associated with the second new trading partner from the Web site;
populating the new trading partner record of the second new trading partner with the configuration details associated with the first new trading partner; and
populating the new trading partner record of the first new trading partner with the configuration details associated with the second new trading partner.

34. A method as recited in claim 33, wherein the collecting comprises presenting a graphical user interface to enable a user to enter the configuration details.

35. A method as recited in claim 33, wherein the publishing comprises publishing the configuration details in XML format.

36. method as recited in claim 33, wherein the publishing comprises publishing the first configuration details at a first Web site associated with the first new trading partner and the second configuration details at a second Web site associated with the second new trading partner.

37. A method as recited in claim 33, wherein the publishing comprises posting the configuration details to a URL (universal resource locator) at the Web site.

38. A method as recited in claim 37, wherein the retrieving comprises addressing the URL to access the configuration details posted to the Web site.

39. A system comprising:
a first computer system at a first new trading partner;
a second computer system at a second new trading partner;
the first computer system collecting first configuration details associated with the first new trading partner and publishing the configuration details to a first Web site;
the second computer system collecting second configuration details associated with the second new trading partner and publishing the configuration details to a second Web site;
the first computer system retrieving the second configuration details from the second Web site and automatically configuring for a new trading relationship with the first new trading partner using the second configuration details; and
the second computer system retrieving the first configuration details from the first Web site and automatically configuring for a new trading relationship with the first new trading partner using the first configuration details.
